(19) United States
(12) Patent Application Publication
(10) Pub. No.: US 2003/0055676 A1
(43) Pub. Date: Mar. 20, 2003

(54) Utility capacity transfer system

(75) Inventor: Timothy Huneycutt, Edmond, OK (US)

Correspondence Address: Martin G. Orzinga, Phillips McFall McCaffrey McVay & Murrah, P.C., One Leadership Square, 12th Floor, 211 N. Robinson Ave., Oklahoma City, OK, 73102, US

(73) Assignee: AUTOMATED ENERGY, INC.

(21) Appl. No.: 10/243,170

(22) Filed: Sep. 12, 2002

Related U.S. Application Data
(60) Provisional application No. 60/318,868, filed on Sep. 14, 2001.

(51) Int. Cl. G06F 17/60

(52) U.S. Cl. 705/1; 705/412

(57) ABSTRACT

An Internet-based method for managing a utility by presenting allocated utility capacity to a customer, presenting a predicted load profile to a customer, presenting available utility capacity, and transferring available utility capacity between entities according to an established transfer policy. The allocated utility capacity includes permitted utility consumption during a certain future period of time. The predicted load profile includes predicted utility consumption of the customer for each certain future period of time and is presented such that any variation between the allocated utility capacity and the predicted load profile is readily apparent. The available utility capacity includes an amount by which allocated utility capacity exceeds predicted utility consumption during each certain future period of time.

This application claims priority to U.S. Provisional Application No. 60/318,868 filed Sep. 14, 2001, which is incorporated by reference in its entirety.

### TECHNICAL FIELD

The present invention relates generally to transferring a utility, particularly an energy utility. More in particular, a utility is managed by presenting allocated utility capacity to a customer, presenting a predicted load profile to a customer, presenting available utility capacity, and transferring available utility capacity between entities according to an established transfer policy.

### BACKGROUND

In the utility industry, data acquisition and analysis systems are used to collect information about utility usage by customers. Data about utility usage can be analyzed to determine a utility customer's pattern of use over time. This pattern is known as a “load profile.”Load profiles may be created from utility consumption data for different time periods, such as, for example, a day, a week, or a year. Demand for electricity, water, gas, and other utilities is generally greatest during daylight and business hours, but may also depend on other factors, such as weather conditions or a customer's production schedule. To operate at a constant output rate, a utility supplier may charge different prices for utility consumption during peak and low demand periods. For example, utility suppliers often price electricity higher during daylight hours when businesses are operating, and lower during nighttime hours.

In general, utility suppliers (e.g., power companies) charge commercial customers for reserving capacity and may allocate resources and charge a price to a customer based on the customer's peak demand. For example, a utility supplier may reserve capacity for a customer for an upcoming time interval (e.g., 12 months) based on the peak demand level for a past time interval (e.g., 12 months). If the customer exceeds the capacity level set by the utility supplier (i.e., the peak demand level) the utility supplier resets the capacity level to the new, higher peak demand, sets a new price, and often charges a penalty.

Typically, once the customer establishes a peak, the utility supplier reserves capacity and the customer must pay for the utility whether it is consumed or not. The utility supplier operates on the assumption that the customer at any time during the upcoming time interval may require the utility at the peak demand level and, therefore, reserves the capacity for the customer. The price charged by the utility supplier reflects reserved capacity at the peak demand level. Accordingly, it is in a customer's interest to avoid random spikes (i.e., short-term high utility use) in the customer's load profile because even a one-time overuse of a utility may result in extended overpaying for a utility that is never consumed.

Energy suppliers typically employ conservative pricing tactics, such as the one discussed above, in order to reduce the risks associated with price fluctuations. Even though energy suppliers generally offer energy at a fixed rate to their customers, the spot price of energy (i.e., the price of energy at a given point in time) is constantly fluctuating. Fluctuations in energy price may depend on factors such as gas prices, coal prices, or other costs associated with the fuel used to create electric energy. To allow for these price fluctuations, energy suppliers build in margins into the offered price of energy to keep the offered price above the production cost. This practice, in effect, passes the risk of price fluctuations onto the customers. For example, the cost to an energy supplier associated with production (e.g., generating, transmitting, and distributing energy) may be $0.02/kWh one day and $0.12/kWh the next. To allow for price variation and to avoid much of the risk, the energy supplier may charge its customers $0.10/kWh every day to ensure a profit.

In theory, deregulation should result in an efficient market for energy. In a deregulated market, energy suppliers face increased competition and should adapt their pricing strategies to attract and maintain customers. Because customers will have more energy suppliers to choose from, energy suppliers will be motivated to offer pricing plans that accurately reflect a customer's actual usage. However, until customers have access to the same information that energy suppliers do, energy suppliers will always have more knowledge and more freedom to set energy prices in their favor. Even though deregulation means that energy suppliers will assume additional risks (e.g., no guaranteed rate of return), customers are not able to evaluate whether the price offered by an energy supplier is fair or inflated. This unequal access to information allows energy suppliers to pass most risks on to customers.

### SUMMARY

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

In one general aspect, a utility is managed by presenting allocated utility capacity to a customer, presenting a predicted load profile to a customer, presenting available utility capacity, and transferring available utility capacity between entities according to an established transfer policy. The allocated utility capacity may include permitted utility consumption during a certain future period of time. The predicted load profile may include predicted utility consumption of the customer for each certain future period of time and may be presented such that any variation between the allocated utility capacity and the predicted load profile is readily apparent. The available utility capacity may include an amount by which allocated utility capacity exceeds predicted utility consumption during each certain future period of time.

Implementations may include one or more of the following features. For example, the allocated utility capacity represents the utility capacity allocated for consumption during one-hour intervals for each hour of an upcoming day. Shares corresponding to utility capacity may be distributed. The shares are redeemable as payment for utility consumption. Each share may represent a preset amount of a utility and may be assigned to a certain period of time.

A utility management program may be determined. The utility management program may include actions for reducing energy consumption. By adopting the utility management program, surplus utility capacity may be created. Available utility capacity may include the surplus utility capacity. The surplus utility capacity may include an amount by which the allocated utility consumption exceeds the predicted utility consumption during a certain time period. Offered available utility capacity and bids received for offered utility capacity may be presented.

After any transfer, adjusted utility capacity may be presented. The adjusted utility capacity may include including allocated utility capacity plus incoming transfers of utility capacity and minus outgoing transfers of utility capacity during a certain period of time. Shares corresponding to utility capacity may be redistributed.

Actual utility consumption may be presented. An actual load profile representing the actual amount of utility consumed during certain period of time may be displayed. Actual utility margins also may be presented. The actual utility margins may include deviation of the actual utility consumption from the adjusted utility consumption for certain periods of time. Actual incremental costs may be presented. The actual incremental costs may include costs associated with the deviation of the actual utility consumption from the adjusted utility capacity for certain time periods. A payment transaction may be completed. The payment transaction may include a reimbursement for a charge associated with utility consumption for a certain period of time.

In another general aspect, a utility is managed by presenting allocated utility capacity to a customer, presenting a predicted load profile to a customer, and transferring utility capacity credit to the customer. The allocated utility capacity may include permitted utility consumption during a certain future period of time. The predicted load profile may include predicted utility consumption of the customer for each certain future period of time and may be presented such that any variation between the allocated utility capacity and the predicted load profile is readily apparent. The utility capacity credit may be issued by another entity and may be redeemable by the customer as payment for utility consumed by the customer.

Implementations may include one or more of the following features. For example, adjusted utility capacity may be presented. The adjusted utility capacity may include allocated utility capacity plus incoming transfers of utility capacity credit during a certain period of time. The utility capacity credit may include a coupon issued by at least one of a utility supplier, a utility management host, and a vendor. The coupon may be issued by a vendor as an incentive for customers to purchase a product or service requiring consumption of the utility. In some cases, the utility capacity credit may be redeemable only for utility purchased from a particular utility supplier.

A user interface having at least one of charts, figures, graphs, text, images, audio, and video may be displayed. Pricing data, cost data, weather data, and usage data may be analyzed. Data may be delivered by at least one of e-mail, facsimile, telephone, satellite transmission, the Web and/or the Internet.

These and other general aspects may be implemented by an apparatus and/or by a computer program stored on a computer readable medium. The computer readable medium may comprise a disk, a client device, a host device, and/or a propagated signal.

Other features and advantages will be apparent from the following description, including the drawings, and from the claims. These, together with other objects of the invention, along with the various features of novelty which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there is illustrated preferred embodiments of the invention.

### DESCRIPTION OF THE DRAWINGS

The invention will be better understood and objects other than those set forth above will become apparent when consideration is given to the following detailed description thereof. Such description makes reference to the annexed pictorial illustrations, graphs, drawings, and appendices wherein:

FIG. 1 is a schematic diagram of a data collection and analysis system.

FIGS. 2 and 3 are graphical user interfaces that may be displayed by the data collection and analysis system of FIG. 1.

FIG. 4 is schematic diagram of a data collection and analysis system.

FIG. 5 is a flow chart illustrating a method that may be implemented by the data collection and analysis system of FIG. 1.

FIGS. 6A, and 6B are graphical user interfaces that may be displayed by the data collection and analysis system of FIG. 1.

FIG. 7 is a schematic diagram of a computer system that may be implemented by the data collection and analysis system of FIGS. 1 and 4.

Like reference symbols in the various drawings indicate like elements.

### DETAILED DESCRIPTION

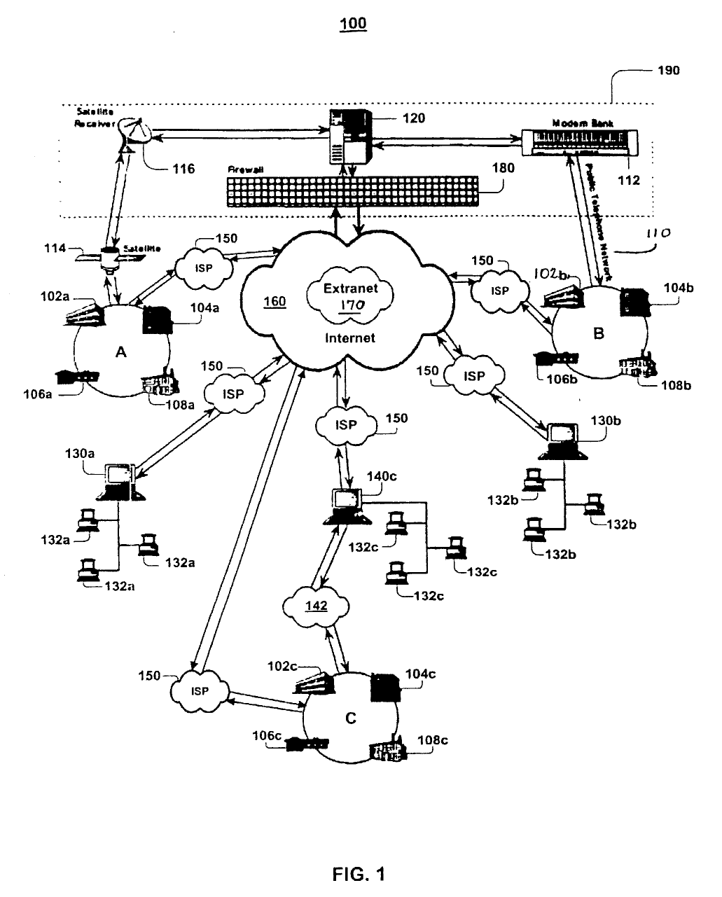

Referring to FIG. 1, a utility data collection and analysis system 100 includes clients in communication with a host 190. The data collection and analysis system 100 is capable of collecting and analyzing utility consumption data and may be configured for customer specific applications. For example, the data collection and analysis system 100 may be implemented by a utility company that collects and analyzes data about customers' utility usage from remote terminal units (“RTUs”) located at each customer's site. In another implementation, the data collection and analysis system 100 includes or is part of an intermediary (e.g., host system) that serves several different organizations by collecting and analyzing utility consumption data and then allowing the individual organizations to access the raw and processed data over a wide area network (e.g., Internet and/or World Wide Web).

Different utility suppliers may serve different customers (i.e., utility customers). For example, utility A may supply a utility to customers 102a, 104a, 106a, and 108a, and utility B may supply a utility to customers 102b, 104b, 106b, and 108b. Different utilities also may include client computers (e.g., 130a, 130b, 140c) for transmitting data to and from the host 190 through an Internet 160. An individual utility also may include software applications 132a, 132b, 132c on client computers 130a, 130b, 130c for processing data pertaining to the individual utility or to the customers of the utility.

Clients, including utility suppliers (e.g., utility A, utility B, or utility C) and utility customers (e.g., 102a, 104a, 106a, 108a), may access host 190. The host 190 may be protected by a firewall 180, and may be accessed through an Internet-enabled extranet 170 provided by the host 190. A user may be given selective access to data stored on host 190, such that the confidentiality of other users' data stored on host 190 is maintained. For example, utility A may be given selective access only to data concerning customers of utility A (e.g., 102a, 104a, 106a, and 108a), while utility B is given access only to data concerning customers of utility B (e.g., 102b, 104b, 106b, and 108b). Individual customers of a utility (e.g., 102a, 104a, 106a, 108a, 102b, 104b, 106b, 108b, 102c, 104c, 106c, and 108c) may be given selective access only to their own data, but not to data of other customers of the same utility or to data of the customers of other utilities. Selected data may be downloaded to the client computer 130a of a user from host 190 through an Internet Service Provider (“ISP”) 150.

In general, the host 190 is configured to perform data acquisition and analysis. In one implementation, the host 190 is an Internet-enabled centralized system that receives utility usage data from meters and RTUs. Customers, utility suppliers, and/or other users of the service then may access the host 190 through the Internet 160 to display and interpret the relevant utility consumption data.

The host 190 may include software and/or hardware for receiving information from the clients. For example, the host 190 may include a modem bank 112 for receiving information transmitted over telephone or cable lines 110 and/or a satellite receiver 116 for receiving information over a wireless transmission link. The host 190 may include one or more server computers 120 running software for receiving data from modem bank 112 or satellite receiver 116, for storing data, and for processing the data. The software may include Internet-enabled analysis software accessible over a wireless Internet connection.

The host 190 may upload a variety of data types from clients (e.g., suppliers and customers). Each client may be associated with one or more customers. Examples of customers include an office building such as 102a, a production facility such as 104a, a residence such as 106a, or an apartment complex such as 108a. The customer may have an RTU configured to monitor and collect utility consumption data from the customer's location. The RTU may upload data from the customer's site directly to the host 190 through wired and/or wireless communications links.

For example, the RTU may send data over the Internet 160 through the ISP 150 to the host 190. The RTU also may indirectly upload data from a customer to host 190 by sending the data over a data transmission link 142 to the utility supplier's host computer 140, which then stores the data and forwards the data to the host 190.

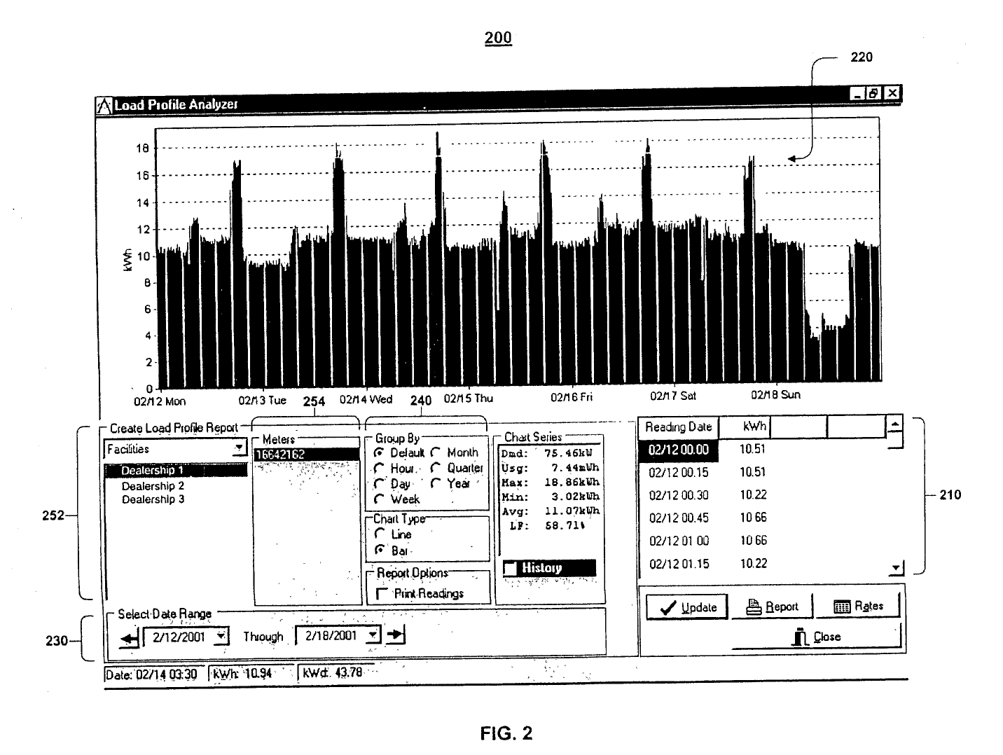

Referring to FIG. 2, a user Interface (“UI”) 200 is displayed by a software application provided by the host 190 (FIG. 1). In one implementation, the UI 200 may be implemented by an Internet-enabled framework, as described in U.S. application Ser. No. 09/828,170, which is incorporated by reference in its entirety. The software application is accessible through extranet 170 (FIG. 1) and is capable of storing energy usage data retrieved from one or more RTUs.

The UI 200 displays utility usage data including a time series 210 of utility units consumed by a RTU at regular intervals. The time series 210 is displayed graphically as a load profile 220. Different time periods of the time series may be selected for graphical display by entering beginning and ending times for the display through a date range selection box 230. The format and density of points in the time series plot may be chosen from several predetermined formats 240. Load profiles may be created from data recorded by one or more RTUs. For example, load profiles may be created for different facilities 252, or for the data from different meters 254 at a facility according to the user's choice.

The load profile 220 displayed in FIG. 2 corresponds to utility consumption (e.g., electric energy consumption) at one of the facilities 252 (e.g., Dealership 1). According to the load profile 220, the peak consumption for Dealership 1 of facilities 252 occurs approximately between the hours of 4:00 p.m. and 8:00 p.m., Monday through Saturday. Using this information, Dealership 1 may be able to negotiate with a utility supplier for a lower monthly rate for future energy because the periods of peak consumption do not coincide with normal periods of high demand (e.g., between 9:00 a.m. and 3:00 p.m., Monday through Friday). A utility supplier also may view the load profile 220 and prospectively offer a competitive rate to Dealership 1 of facilities 252 based on its usage pattern. Without the availability of the information contained in the time series data 210 and the load profile 220, Dealership 1 typically would have to purchase energy from a supplier based on total energy consumption for a month or based on peak energy consumption during a period of time, and could not benefit from the fact that its peak consumption occurs during low demand hours.

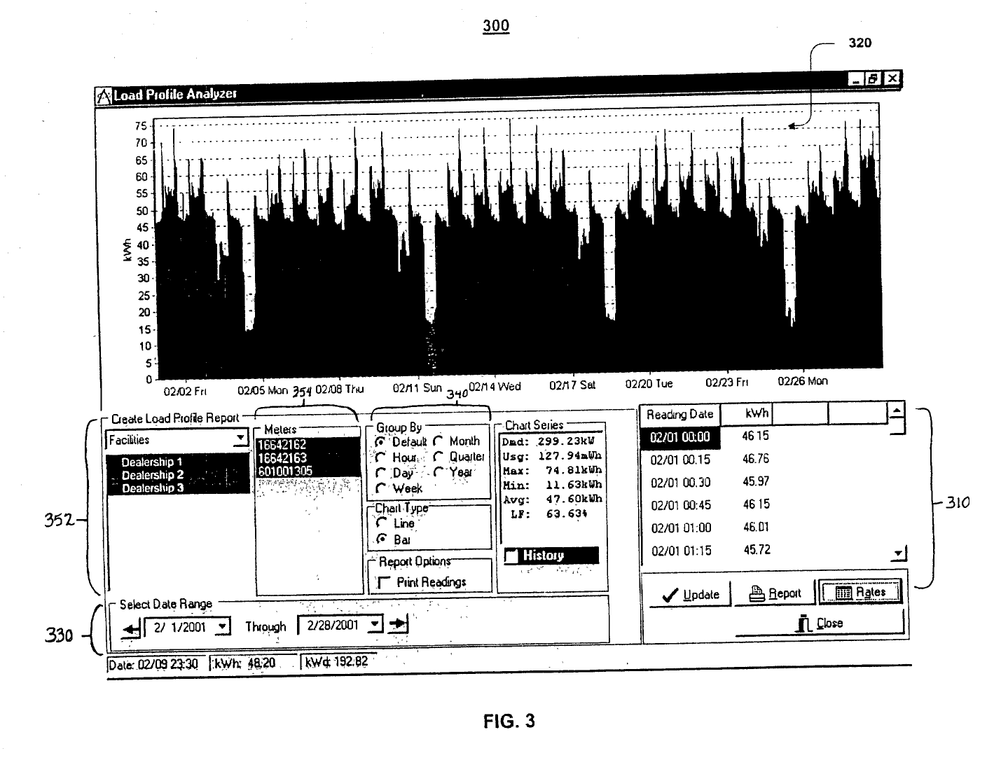

Referring to FIG. 3, a user interface (UI) 300 displays an aggregate load profile 320 for energy consumption of different facilities 252 (Dealership 1, Dealership 2, and Dealership 3) during the month of February 2001. Aggregate load profiles 320 may be created from data derived from multiple facilities (e.g., RTUs). For example, load profiles tracking the utility consumption of a group of a customer's facilities, of a group of customers, of a geographic region, or of a group of sites served by a particular utility plant may be created and displayed. Having aggregate information about a customer's utility consumption on a fine timescale (measured every hour, or every few minutes) is useful both to the utility supplier and to the utility customer, as it permits them to negotiate a price for the utility in an efficient market. Load profiles 320 for several different facilities 352 may be analyzed to permit a customer to “package” facilities together in order to negotiate a package rate for the group of facilities. If some facilities use energy mostly at night and others generally consume energy during the day, their collective consumption may not vary greatly, which may be attractive for a utility supplier that wants to match a relatively constant supply to relatively constant demand. A utility supplier may offer price incentives to a customer who purchases the utility for the entire group, since the consumption of a large group generally fluctuates less than the consumption of an individual. Additionally, the utility supplier may offer incentives to encourage a group to use energy at a steady rate, with relatively low fluctuations.

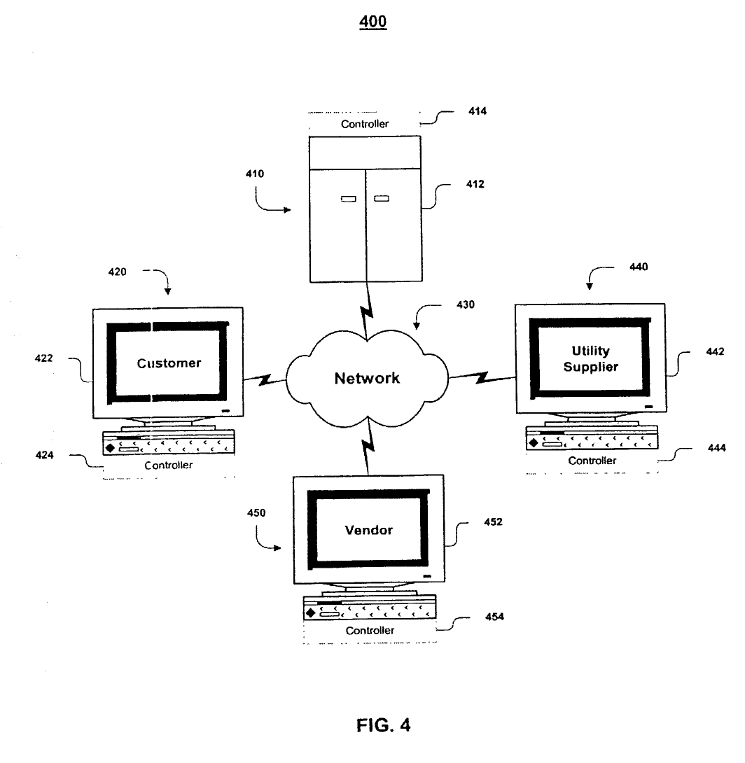

Referring to FIG. 4, a utility data collection and analysis system 400 is configured to transfer electronic data related to utility consumption. The utility data and analysis system 400 includes a utility management host system 410 in communication with a customer system 420 through a network 430. The utility management host system 410 and customer system 420 also are in communication with a utility supplier system 440 and a vendor system 450 through the network 430. The data collection and analysis system 400 is capable of collecting and analyzing utility consumption data and may be configured for customer-specific applications. The utility management host system 410 is configured to coordinate and/or otherwise facilitate interaction between the customer system 420, the utility supplier system 440, and the vendor system 450.

In general, the utility management host system 410 includes a computer system having hardware and/or software components for communicating with the customer system 420, the network 430, the utility supplier system 440, and the vendor system 450. The utility management host system 410, customer system 420, utility supplier system 440, and vendor system 450 each may include one or more general-purpose computers (e.g., personal computers), one or more special-purpose computers (e.g., devices specifically programmed to communicate with each other), or a combination of one or more general-purpose computers and one or more special-purpose computers. The utility management host system 410, customer system 420, utility supplier system 440, and vendor system 450 may be structured and arranged to communicate using various communication protocols (e.g., HTTP, WAP), encapsulation protocols (e.g., UDP), and/or proprietary protocols; to establish peer-to-peer (e.g., socket) connections between network elements; and/or to operate within or in concert with one or more other systems (e.g., the Internet and/or World Wide Web).

In one implementation, the utility management host system 410 includes a utility management host device 412 operating under the command of a utility management host controller 414, the customer system 420 includes a customer client device 422 operating under the command of a customer client controller 424, the utility supplier system 440 includes a utility supplier client device 442 operating under the command of a utility supplier client controller 444, and the vendor system 450 includes a vendor client device 452 operating under the command of an vendor client controller 454 An example of a device (e.g., host device 412 and/or client device 422, 442, 452) is a general-purpose computer capable of responding to and executing instructions in a defined manner. Other examples include a special-purpose computer, a personal computer (“PC”), a workstation, a server, a component, machine, tool, other physical or virtual equipment, or some combination thereof capable of responding to and executing instructions.

An example of a controller (e.g., host controller 414 and/or client controller 424, 444, 454) is a software application loaded on a device (e.g., host device 412 and/or client device 422, 442, 452) for commanding and directing communications enabled by the device. Other examples include a computer program, a piece of code, an instruction, another device, or some combination thereof, for independently or collectively instructing the device to interact and operate as desired. The controller (e.g., host controller 414 and/or client controller 424, 444, 454) may be embodied permanently or temporarily in any type of machine, component, physical or virtual equipment, storage medium, or propagated signal capable of providing instructions to a device (e.g., host device 412 and/or client device 422, 442, 452). As indicated by the broken lines, the controller 414, 424, 444, and/or 454 may be separate from or integral with the associated device.

The network 430 may include one or more delivery networks for directly or indirectly connecting the utility management host system 410, the customer system 420, the utility supplier system 440, and the vendor system 450 irrespective of physical separation. Examples of delivery networks include, but are not limited to, a local area network (“LAN”), a wide area network (“WAN”), the Internet, the Web, a telephony network (e.g., analog, digital, wired, wireless, PSTN, ISDN, or xDSL), a radio network, a television network, a cable network, a satellite network, and/or any other network configured to carry data. Each network may include one or more elements, such as, for example, intermediate nodes, proxy servers, routers, switches, adapters, and wired or wireless data pathways, configured to direct and/or deliver data.

The utility management host system 410, the customer system 420, and the utility supplier system 440 may be arranged and operate as described above in connection with FIGS. 1-3. In one implementation, the data collection and analysis system 400 is structured and arranged to operate in a deregulated utility market environment. In particular, the utility management host system 410 is configured to enable substantially real-time access to utility data by the customer system 420, the utility supplier system 440, and/or the vendor system 450.

The vendor system 450 includes goods, personnel, and/or equipment necessary to provide goods and/or to perform services for customers. Typically, the vendor system 450 offers products and/or services that involve the consumption of a utility. For example, the vendor system 450 may offer products that consume a utility (e.g., television, washing machine, oven) and/or services that involve consuming a utility (e.g., pay-per-view television event, detergent, baking products). The vendor system 450 may offer one or any combination of services as well as a variety of goods and/or services. The goods and/or services offered may be related to one or more brands, suppliers, providers, and/or manufactures.

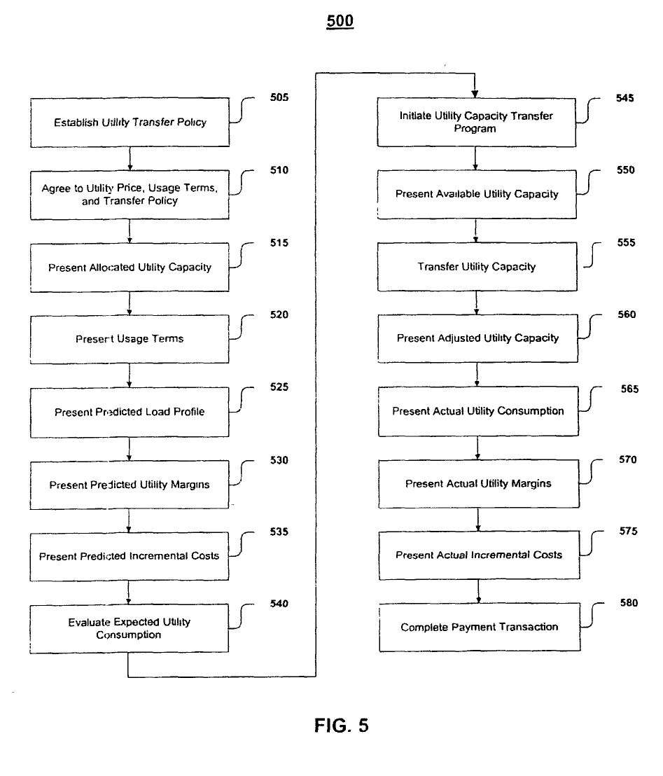

Referring to FIG. 5, the utility data collection and analysis system 400 (FIG. 4) operates according to a procedure 500 for transferring utility capacity between entities. The procedure 500 may be implemented by any suitable type of hardware (e.g., device, computer, computer system, equipment, component), software (e.g., program, application, instructions, code), storage medium (e.g., disk, external memory, internal memory, propagated signal), or combination thereof.

In one implementation, utility capacity is transferred between customers of one or more utility suppliers. As discussed above, a utility supplier (e.g., power company) may charge a customer for reserving capacity based on the customer's past peak demand for certain time interval (e.g., past twelve months). In this type of pricing arrangement, the utility supplier establishes a baseline capacity (e.g., 1800 kWh), charges the customer for the right to use the capacity even if the customer does not use the total amount, and charges the customer a penalty if the baseline capacity is exceeded. In a deregulated market, however, it may not be practical for a utility supplier to adopt such pricing strategies, especially if the customers have access to real-time utility consumption data. Indeed, if customers are able to accurately monitor actual usage, competition may dictate that utility suppliers allow customers to establish a secondary market for allocated utility capacity.

Initially, a utility transfer policy is established (step 505). In general, the utility transfer policy 505 includes restrictions and/or guidelines regulating the transfer of utility capacity between entities. For example, the utility transfer policy 505 may include geographic limitations, quantity limitations, time limitations, and/or other limitations regarding how, when, and where a utility is transferred. In one implementation, the established utility transfer policies 505 permit and, in effect, create a secondary market for allocated utility consumption. The established utility transfer policies 505, however, may restrict the transfer of utility capacity to customers of a common utility supplier.

Establishing the utility transfer policy 505 may include analyzing historical and/or predicted pricing data, cost data, weather data, usage data, or other supply-and-demand related data. For example, utility suppliers may analyze utility consumption data in order to anticipate fluctuating demand so that resources can be allocated to meet the demand and to set demand-dependent rates and policies. In this way, utility suppliers are able to predict future demand, determine prices and policies, and create an efficient market for the utility. Based on such analysis, a utility supplier may set a permissive transfer policy to attract customers when the demand for a utility is predicted to be low. The utility supplier also may set a permissive transfer policy when demand is predicted to be high in order to maximize the efficiency of utility production. Maximizing efficiency may be a primary objective of a utility supplier to keep prices in check, especially in cases where the government sets limits on what utility suppliers can charge for a utility.

The utility supplier and/or host may establish the utility transfer policy 505. If calculated by the utility supplier, the utility transfer policy 505 may be transmitted to the host for posting. The utility transfer policy 505 may be transmitted to the host by any suitable delivery method including, but not limited to, delivery by e-mail, facsimile, telephone, satellite transmission, the Web and/or the Internet.

In one implementation, the host presents the utility transfer policy 505 to customers that access the host through the Internet. Customers may be required to enter a user identification and password to access the host. The host may present the utility transfer policy 505 to the customer as a UI (e.g., Web page). This and other UIs presented by the host may have charts, figures, graphs, text, images, audio, video, and/or any other type of content. The host may display several different utility transfer policies 505 so that customers are able to evaluate competing utility transfer policies of one or more utility suppliers.

Next, an agreement is reached as to utility price, usage terms, and utility transfer policy (step 510). In general, agreement to purchase a utility is reached between the customer and a utility supplier. Typically, the agreement 510 involves purchasing a utility in compliance with the usage terms at a standard utility price and purchasing a utility in violation of the usage terms at a penalized utility price. The agreement 510 also provides the conditions under which allocated utility capacity may be transferred. Agreeing to utility price and usage term may include locking in estimated utility prices and usage terms for the next day.

Reaching the agreement 510 to utility prices and usage terms also may include determining a utility management program. In general, a utility management program includes actions for reducing energy consumption and/or minimizing incremental cost. The utility management program may be tailored to the specific facilities, equipment, and/or requirements of the customer. The utility management program may include, for example, offloading the use of certain equipment and/or facilities during peak hours. The utility management program also may include sufficiently reducing utility consumption by a certain amount (i.e., percentage) so as to comply with the usage terms or to achieve a reduced peak demand level.

The utility management program may include specific suggested actions to take in order to comply with the usage terms or to achieve the reduced peak demand level. For example, the utility management program may suggest shutting down specified energy-consuming devices (e.g., generators, elevators, lights, air conditioners) in a particular facility for a certain period of time. The utility management program may suggest an enterprisewide approach involving several different combinations of devices and/or facilities. The utility management program also may include user preferences for customizing the suggested action to minimize total down time, minimize down time during normal business hours, minimize the total number of idle devices, minimize the number of idle devices during normal business hours, and/or otherwise minimize customer inconvenience.

Determining a utility management program may involve having the customer select one of several proposed utility management programs or elements from one or more proposed utility management programs. In general, selection of a proposed utility management program (or elements of a utility management program) includes determining avoidable utility consumption and/or deciding upon the least burdensome course of action that will achieve a certain reduction. A utility management program (or elements of a utility management program) may be assigned a particular level (e.g., Level 1, Level 2, Level 3) based on the severity of the action required to reduce consumption and/or the burden on the customer to achieve a certain reduction. For example, a Level 1 utility management program may involve a subtle change in the operation of certain equipment, while a Level 3 utility management program may involve drastically removing certain equipment and/or facilities from use.

In one implementation, the host proposes several utility management programs for reducing utility consumption. The host may present a UI (e.g., Web page) including load profiles corresponding to each proposed utility management program so that a customer can readily compare the benefits and burdens of various proposed utility management programs. The customer may select and/or determine the most appropriate utility management program based on avoidable utility consumption and/or the burden to achieve a certain reduction. The most appropriate utility management profile may correspond to a load profile that achieves compliance with usage terms while minimizing customer inconvenience, for example, by offloading only nonessential facilities and/or equipment.

By agreeing to reduce utility usage according to the planned utility management program, the customer may be able to negotiate a lower standard price for the utility. In general, this option will be available to a customer when the utility management program reduces energy consumption to levels well within usage terms.

Reaching the agreement 510 to utility prices and usage terms also may include negotiating lower standard prices in exchange for stricter usage terms and/or more restrictive transfer policies. Higher penalties for violating the usage terms also may accompany lower standard prices. For example, prior to reaching the agreement 510, the customer may inform the host and/or the utility supplier of a planned utility management program and may request lower prices.

After the agreement 510 has been reached, allocated utility capacity is presented (step 515). In general, allocated utility capacity 515 includes permitted utility consumption during a certain period of time. For example, allocated utility capacity 515 may represent the utility capacity (kWh) allocated for consumption during the one-hour (or other time period) intervals for each hour of the next day. The allocated utility capacity 515 may correspond to and be displayed with locked-in utility prices. The allocated utility capacity 515 also may be displayed with the usage terms and/or a planned utility management program for reference.

In general, utility capacity 515 is allocated according to the agreement 510 (e.g., accepted usage terms). For example, the accepted usage terms may be segmented into time periods (e.g., months, days, weekdays, peak hours, hours), and the allocated utility capacity 515 associated with each time period may be distributed and displayed to a customer.

Allocating utility capacity 515 may include distributing shares corresponding to utility capacity. The shares may be redeemable as payment for utility consumption prior to or at the time of billing. Each share may represent a preset amount of a utility and may be assigned to a certain period of time (e.g., 1 share=1 kWh in a given hour). If, for example, the CUB is segmented into one-hour intervals and the utility capacity for the hour between 9:00 a.m. and 10:00 a.m. is 1500 kWh, then the customer would be allocated 1500 shares for that hour. Shares also may be classified according to periods of time (e.g., year, month, weekday, day, peak hours, hour). Share distribution may be graphically displayed by a UI (e.g., Web page) as a chart, figure, graph, text, or image or representing the utility capacity at different periods of time (e.g., hourly) for the next day.

The host or the utility supplier may establish the allocated utility capacity 515. If established by the utility supplier, the allocated utility capacity 515 may be transmitted to the host for posting. The allocated utility capacity 515 may be transmitted to the host by any suitable delivery method including, but not limited to, delivery by e-mail, facsimile, telephone, satellite transmission, the Web and/or the Internet.

In one implementation, the host posts and releases the allocated utility capacity 515 to customers that access the host through the Internet. The host may present the allocated utility capacity 515 to the customer as a UI (e.g., Web page) having charts, figures, graphs, text, images, audio, video, and/or any other type of content. The allocated utility capacity 515 may be displayed with estimated prices, usage terms, predicted load profile, predicted utility margins, and/or predicted incremental costs in one-hour (or other time period) increments representing the utility capacity (kWh) allocated for consumption during each one-hour (or other time period) interval of the next day.

Then, usage terms are presented (step 520). In general, the usage terms 520 include limitations and/or constraints on the utility prices. For example, the usage terms 520 may represent a utility usage threshold below which a certain utility price applies. The usage terms may be presented with utility prices to show applicable constraints for each time period (e.g., each hour).

Presenting the usage terms 520 may include determining and displaying a customer usage baseline (“CUB”). A CUB may be displayed as an hourly (or other time period) usage profile illustrating the threshold limits below which standard rates apply. The CUB may be individualized for each customer and tailored to the permitted, i.e., agreed upon, utility usage of the customer.

In general, the threshold limit is set such that a customer's normal usage does not trigger higher prices and penalties. However, in some cases, the CUB may be used as an incentive for a customer to decrease normal usage in order to take advantage of a special low rate. In either case, the CUB conveys the usage terms 520 in a clear manner that protects the revenues for utility suppliers and protects customers from unexpected high prices.

The host and/or the utility supplier may calculate usage terms 520 based on one or more of historical and/or predicted pricing data, cost data, weather data, usage data, or other supply-and-demand related data. If calculated by the utility supplier, the usage terms 520 may be transmitted to the host for posting.

In one implementation, the host posts and releases the usage terms 520 to customers that access the host through the Internet. The host may present the usage terms 520 to the customer as a UI (e.g., Web page). The UI may graphically display the usage terms 520 with the utility prices in one-hour (or other time period) increments representing utility usage thresholds (kWh) below which the estimated price applies. To illustrate, between the hours of 9:00 a.m. and 10:00 a.m., an estimated price of $0.05/kWh may be applicable only if the customer uses less than 1,600 kWh. Otherwise, a higher price and/or penalties may be applied.

Then, a predicted load profile is presented (step 525). In general, the predicted load profile 525 includes the utility usage of a customer for a certain time period. For example, the predicted load profile 525 may represent the predicted utility usage for a customer at each hour (or other time interval) for the next day. The predicted load profile 525 may be presented with the estimated utility prices and/or the usage terms 520 to illustrate the applicability of certain estimated utility prices to certain amounts of predicted utility consumption as well as to illustrate any variation between the usage terms 520 and the predicted load profile 525.

Predicting the load profile 525 representing future utility consumption may include analyzing one or more of a particular customer's previous load profiles. Different load profiles corresponding to utility usage at various times may be analyzed to determine historical trends or patterns in utility usage. For example, previous load profiles may be analyzed to determine whether certain periods of time or certain other factors are determinative of utility usage.

The host and/or the utility supplier may create the predicted load profile 525 using proprietary forecasting software, for example. The predicted load profile 525 may be based on one or more of historical and/or predicted pricing data, cost data, weather data, usage data, or other supply-and-demand related data. If created by the utility supplier, the predicted load profile 525 may be transmitted to the host for posting.

In one implementation, the host posts and releases the predicted load profile 525 to customers that access the host through the Internet. The host may present the predicted load profile 525 to the customer as a UI (e.g., Web page). The UI may display the predicted load profile 525 with the utility prices and/or the usage terms 500 in one-hour (or other time period) increments representing the predicted utility usage (kWh) for the next day.

Next, predicted utility margins are presented (step 530). In general, the predicted utility margins 530 include the deviation of the predicted load profile 525 from the usage terms 520 for a certain time period. For example, the predicted utility margins 530 may represent the difference between the predicted utility usage and the usage terms 520 (e.g., CUB) at each hour (or other time interval) for the next day. The predicted utility margins 530 may be presented with the estimated utility prices, the usage terms 520, and/or the predicted load profile 525 to illustrate the incremental and/or total variation between the usage terms 520 and the predicted load profile 525 for each hour (or other time period) of the next day.

Determining the predicted utility margins 530 may include calculating the variation of the CUB from the predicted load profile 525. The variation of the CUB and the predicted load profile 525 may be calculated by taking the difference between predicted utility consumption and the CUB threshold limit for each time period (e.g., each hour).

The host and/or the utility supplier may calculate the predicted utility margins 530. If calculated by the utility supplier, the predicted utility margins 530 may be transmitted to the host for posting.

In one implementation, the host posts and releases the predicted utility margins 530 to customers that access the host through the Internet. The host may present the predicted utility margins 530 to the customer as a UI (e.g., Web page). The UI may display the predicted utility margins 530 with the estimated utility prices, the usage terms 520, and/or the predicted load profile 525 in one-hour (or other time period) increments representing the deviation (kWh) of the predicted load profile 525 from the usage terms 520 during each hour (or other time period) of the next day.

Then, predicted incremental costs are presented (step 535). In general, the predicted incremental costs 535 include the costs associated with the deviation of the predicted load profile 525 from the usage terms 520 for a certain time period. For example, the predicted incremental costs 535 may represent specific monetary values associated with the deviation of the predicted load profile 525 from the usage terms 520 during each hour (or other time period) of the next day. The predicted incremental costs 535 may be displayed with the estimated utility prices, the usage terms 520, the predicted load profile 525, and/or the predicted utility margins 530 for reference.

Determining the predicted incremental costs 535 may include associating a monetary value with the predicted utility margins 530. The associated monetary value may include the predicted utility prices and/or a fixed or graded penalty for exceeding the usage terms 520 (e.g., CUB). The predicted incremental costs 535 may be calculated by multiplying the associated monetary values by the predicted utility margins 530 for each hour (or other time period). Total incremental costs may be calculated for a specified day, month, or year.

The host and/or the utility supplier may calculate the predicted incremental costs 535. If calculated by the utility supplier, the predicted incremental costs 535 may be transmitted to the host for posting.

In one implementation, the host posts and releases the predicted incremental costs 535 to customers that access the host through the Internet. The host may present the predicted incremental costs 535 to the customer as a UI (e.g., Web page). The UI may display the predicted incremental costs 535 with the estimated utility prices, the usage terms 520, the predicted load profile 525, and/or the predicted utility margins 530 in one-hour (or other time period) increments representing the cost ($) associated with the predicted utility margins 530 (kWh) during each hour (or other time period) of the next day.

Next expected utility consumption is evaluated (step 540). In general, expected utility consumption 540 includes an estimated amount of a utility required for a certain period of time. For example, future utility consumption may represent the estimated amount of a utility required to operate necessary facilities and/or equipment of a customer for each hour (or other time period) of the next day.

Evaluating expected utility consumption 540 may include confirming that future utility consumption is consistent with the presented predicted load profile 525, for example, by analyzing the data and/or underlying assumptions used to create the predicted load profile 525 and comparing them to the forecasted data for the next day.

The customer and/or host may evaluate future utility consumption in light of the estimated utility prices, usage terms 520 (e.g., CUB), predicted load profile 525, predicted utility margins 530, and/or predicted incremental costs 535. For example, when presented with such information, the customer and/or host can evaluate whether the predicted incremental costs 535 associated with certain utility consuming activities planned for the next day are worth undertaking. In some cases, it may be cost effective for the customer to curtail certain activities and/or offload certain facilities to avoid high prices and penalties, particularly during peak hours.

In one implementation, the host prompts the customer to confirm that the predicted load profile 525 is consistent with expected utility consumption 540 for the next day. This allows the customer to take into account any special circumstances of the predicted load profile 525 and/or of the next day, such as, for example, unusually high temperatures or exceptionally high production requirements. Confirming that the predicted load profile 525 is consistent may be accomplished by viewing and interacting with a UI (e.g., web page) displaying the presented load profile.

After expected utility consumption 540 is evaluated, a utility capacity transfer program is initiated (step 545). In general, a utility transfer program 545 includes actions for trading utility capacity according to the established utility transfer policy 505. The utility capacity transfer program 545 may be tailored to the specific facilities, equipment, and/or requirements of the customer.

In one implementation, the utility capacity transfer program 545 includes presenting available utility capacity (step 550). In one implementation, available utility capacity 550 includes surplus utility capacity, i.e., the amount by which the allocated utility consumption exceeds the predicted (or expected) utility consumption 540 during a certain time period. Surplus utility capacity may be determined, for example, by analyzing the predicted utility margins 530 and/or predicted incremental costs 535. Time periods and/or graphical areas in which predicted (or expected) utility consumption 540 is below allocated utility consumption are identified as surplus time periods and the amounts corresponding to such surplus time periods are identified as surpluses.

Surplus utility capacity also may be created. For example, the utility capacity transfer program 545 may include, for example, offloading the use of certain nonessential equipment and/or nonessential facilities during certain periods of time so that utility consumption during such periods of time is below allocated utility consumption. The utility capacity transfer program 545 may suggest an enterprise-wide approach involving several different combinations of devices and/or facilities. The utility capacity transfer program 545 also may include user preferences for customizing the actions in order to achieve a certain surplus amount while minimizing down time, idle equipment, and/or customer inconvenience.

In another implementation, the available utility capacity 550 includes utility capacity credit, i.e., a transferable unit associated with another entity that is redeemable by a customer for utility capacity. For example, the utility capacity credit may include an electronic or paper coupon issued by a utility supplier, the utility management host, and/or the vendor.

The host, the customer, and/or the utility supplier may calculate and present the available utility capacity 550 (e.g., surplus utility capacity, utility capacity credit). If calculated by the customer or the utility supplier, the predicted result may be transmitted to the host for posting.

In one implementation, the host posts and releases the available utility capacity 550 to customers that access the host through the Internet. The host may present the available utility capacity 550 to the customer as a UI (e.g., Web page). The UI may display the surplus of the available utility capacity 550 (kWh) during each hour (or other time period) of the next day.

Next, utility capacity is transferred (step 555). In general, utility capacity 555 is transferred between entities according to the established transfer policy 505. Transferring utility capacity 555 may include offering utility capacity, bidding on offered utility capacity, and/or paying for transferred utility capacity. Payment for transferred utility capacity 555 may include monetary compensation, as well as, transferable utility capacity and/or utility capacity credit. Transferring utility capacity 555 also may include sending and/or receiving utility capacity credit.

In one implementation, utility capacity 555 is transferred between a first customer having a surplus of utility capacity and a second customer desiring utility capacity. For example, a first customer may offer surplus utility capacity by posting information through the utility management host. Customers desiring utility capacity may access the utility management host, view information regarding offered utility capacity, and then submit bids on offered surplus utility capacity. The utility management host may coordinate the offers and/or bids for utility capacity and facilitate communication between customers. The utility management host also may coordinate payment and/or compensation for transferred utility capacity 555.

In another implementation, utility capacity credit is transferred to a customer from a utility supplier. For example, a utility supplier may issue utility capacity credit as an incentive for customers to consume the utility. Utility suppliers may solicit and/or reward customers by providing coupons that are redeemable as payment for utility consumption. Typically, a utility supplier will issue utility capacity credit prior to consumption of the utility by the customer.

In another implementation, utility capacity credit is transferred to a utility customer from the utility management host. For example, the utility management host may issue utility capacity as an incentive for customers to use the information services of the utility management host. The utility management host may issue utility capacity credit to a particular customer as a reward for previous use of the information services or for recommending other customers to use the information services of the utility management host.

In yet another implementation, utility capacity credit is transferred to a customer from a vendor. For example, a vendor may issue utility capacity credit as an incentive for a customer to purchase a product and/or service. Typically, the product or service will require consumption of the utility. One example is a vendor of washing machines issuing utility capacity credit corresponding to a certain number of hours and/or wash cycles. Another example is a vendor of a pay-per-view sporting event issuing utility capacity credit for the electricity consumed by the television during the event. A vendor may establish a business relationship with a particular utility supplier and agree to issue utility capacity credit (e.g., coupons) that is redeemable only for utility purchased from the particular supplier utility.

After utility capacity 555 has been transferred, adjusted utility capacity is presented (step 560). In general, adjusted utility capacity 560 includes allocated utility capacity 515 plus/minus any incoming/outgoing transfers of utility capacity 555 (or utility capacity credit) during a certain period of time.

Adjusting the utility capacity 560 may include redistributing shares corresponding to available utility capacity 550. As described above, the shares may be redeemable as payment for utility consumption prior to or at the time of billing. Share redistribution may be graphically displayed by a UI (e.g., Web page) representing the utility capacity at different periods of time (e.g., each hour) for the next day.

The host or the utility supplier may calculate the adjusted utility capacity 560. If calculated by the utility supplier, the adjusted utility capacity 560 may be transmitted to the host for posting.

In one implementation, the host posts and releases the adjusted utility capacity 560 to customers that access the host through the Internet. The host may present the adjusted utility capacity 560 to the customer as a UI (e.g., Web page). The adjusted utility capacity 560 may be displayed with the estimated utility prices, the usage terms 520, the predicted load profile 525, the predicted utility margins 530, the predicted incremental costs 535, and/or the allocated utility capacity 515 in one hour (or other time period) increments representing the available utility capacity 550 (kWh) for consumption during each one-hour (or other time period) interval of the next day.

Presenting the adjusted utility capacity 560 may include displaying a current balance of shares. The current balance of shares graphically may represent the consumed and remaining utility capacity. As discussed above, each share may be dedicated for use during a particular time period. Accordingly, displaying the current balance of shares may include displaying a balance associated with each time period. For example, a positive or negative balance may be presented for each hour (or other time period) interval of a particular day to show a surplus or deficit of utility capacity.

Next, actual utility consumption is presented (step 565). In general, the actual utility consumption 565 includes the actual amount of utility consumed in a certain period of time. For example, actual utility consumption 565 may be displayed as an actual load profile representing the actual amount of utility consumed during each hour of a particular day. The actual utility consumption 565 may be displayed with the estimated prices, the usage terms 520, the predicted load profile 525, the predicted utility margins 530, the predicted incremental costs 535, and/or the allocated utility capacity 515 for reference.

Typically, the presentation of the actual utility consumption 535 occurs substantially in real time or with relatively short delays between the time of actual utility consumption 565 and the time of presentation. Determining the actual utility consumption 565 may include receiving utility data corresponding to utility consumption from the customer. The customer may include facilities and/or equipment including RTUs capable of collecting and transmitting utility consumption data substantially in real time as the utility is consumed.

The host and/or the utility supplier may calculate the actual utility consumption 565 using utility monitoring software, for example. If calculated by the utility supplier, the actual utility consumption 565 may be transmitted to the host for posting.

In one implementation, the host posts and releases the actual utility consumption 565 to customers that access the host through the Internet. The host may present the actual utility consumption 565 to customers as a UI (e.g., Web page). The actual utility consumption 565 may be displayed as an actual load profile with the estimated utility prices, the usage terms 520 (e.g., CUB), the predicted load profile 525, the predicted utility margins 530, the predicted incremental costs 535, and/or the allocated utility capacity 515 in one-hour (or other time period) increments representing the current level of utility consumption (kWh) during a certain one-hour (or other time period) interval of a particular day. For example, at 3:15 p.m., the actual utility consumption 565 may be displayed as an actual load profile indicating the current total amount of utility consumed as of 3:15 p.m. as well as the current total amount of utility consumed between 2:00 p.m. and 3:00 p.m.

Then, actual utility margins are presented (step 570). In general, the actual utility margins 570 include the deviation of the actual utility consumption 565 from the adjusted utility capacity 560 for a certain period of time. For example, the actual utility margins 570 may represent the difference (kWh) between the actual utility consumption 565 and the adjusted utility capacity 560 during each hour (or other time period) of the day. Daily or monthly utility margin totals may be calculated and presented. The actual utility margins 570 may be displayed with the estimated utility prices, the usage terms 520, the predicted load profile 525, the predicted utility margins 530, the predicted incremental costs 535, the allocated utility capacity 515, the adjusted utility capacity 560, and/or the actual utility consumption 565 for reference.

Typically, the presentation of the actual utility margins 570 occurs substantially in real time or with relatively short delays between the time of actual utility consumption 565 and the time of presentation. Determining the actual utility margins 570 may include calculating a surplus and/or a deficit of allocated utility capacity 515 for a certain period of time. A surplus of utility capacity indicates that for a certain period of time the actual utility consumption 565 is below the adjusted utility capacity 560. A deficit of utility capacity indicates that for a certain period of time the actual utility consumption 565 is exceeding the adjusted utility capacity 560.

Presenting the actual utility margins 570 may include displaying a current balance of shares. The current balance of shares graphically may represent the consumed and remaining allocated utility capacity 515. As discussed above, each share may be dedicated for use during a particular time period. Accordingly, displaying the current balance of shares may include displaying a balance associated with each time period. For example, a positive or negative balance may be presented for each hour (or other time period) interval of a particular day to show a surplus or deficit of utility capacity.

The host and/or the utility supplier may calculate the actual utility margins 570. If calculated by the utility supplier, the actual utility margins 570 may be transmitted to the host for posting.

In one implementation, the host posts and releases the actual utility margins 570 to customers that access the host through the Internet. The host may present the actual utility margins 570 to customers as a UI (e.g., Web page). For example, the actual utility margins 570 may be displayed with the estimated utility prices, the usage terms 520 (e.g., CUB), the predicted load profile 525, the predicted utility margins 530, the predicted incremental costs 535, the allocated utility capacity 515, the adjusted utility capacity 560, and/or the actual utility consumption 565 in one-hour (or other time period) increments representing the current deviation (kWh) of the actual utility consumption 565 from the allocated utility capacity 515 during a certain one-hour (or other time period) interval of a particular day. For example, at 3:15 p.m., the actual utility margins 570 may indicate the current total deviation of the actual utility consumption 565 from the adjusted utility capacity 560 as of 3:15 p.m. as well as the deviation between the hours of 2:00 p.m. and 3:00 p.m.

Next, actual incremental costs are presented (step 575). In general, the actual incremental costs 575 include the costs associated with the deviation of the actual utility consumption 565 from the adjusted utility capacity 560 for a certain time period. For example, the actual incremental costs 575 may represent specific monetary values associated with the deviation of the actual utility consumption 565 (e.g., actual load profile) from the adjusted utility capacity 560 during each hour (or other time period) of a particular day. The actual incremental costs 575 may be displayed with the estimated utility prices, the usage terms 520, the predicted load profile 525, the predicted utility margins 530, the predicted incremental costs 535, the allocated utility capacity 515, the adjusted utility capacity 560, the actual utility consumption 565, and/or the actual utility margins 570 for reference.

Typically, the presentation of the actual incremental costs 575 occurs substantially in real time or with relatively short delays between the time of actual utility consumption 565 and the time of presentation. Determining the actual incremental costs 575 may include associating a monetary value with the actual utility margins 570. The associated monetary value may include the locked-in utility prices and/or a fixed or graded penalty for exceeding the adjusted utility capacity 560. The actual incremental costs 575 may be calculated by multiplying the associated monetary values by the actual utility margins 570 for each hour (or other time period). Total incremental costs may be calculated for a specified day, month, or year.

The host and/or the utility supplier may calculate the actual incremental costs 575. If calculated by the utility supplier, the actual incremental costs 575 may be transmitted to the host for posting.

In one implementation, the host posts and releases the actual incremental costs 575 to customers that access the host through the Internet. The host may present the actual incremental costs 575 to the customer as a UI (e.g., Web page). The UI may display the actual incremental costs 575 with the estimated utility prices, the usage terms 520, the predicted load profile 525, the predicted utility margins 530, the predicted incremental costs 535, the allocated utility capacity 515, the adjusted utility capacity 560, the actual utility consumption 565, and/or the actual utility margins 570 in one-hour (or other time period) increments representing the actual cost ($) associated with the actual utility margins 570 (kWh) during each hour (or other time period) of the next day. For example, at 3:15 p.m., the actual incremental costs 575 may indicate the current total costs incurred as of 3:15 p.m. as well as the costs incurred between the hours of 2:00 p.m. and 3:00 p.m.

Finally, a payment transaction is completed (step 580). In general, a payment transaction 580 includes a reimbursement for a charge associated with utility consumption for a certain period of time. For example, the charge may be presented to a customer as a bill representing a total monetary amount due to a utility supplier for a particular month. The bill may be presented in electronic (e.g., e-mail, Web page) or paper form with the estimated utility prices, the usage terms 520, the predicted load profile 525, the predicted utility margins 530, the predicted incremental costs 535, the allocated utility capacity 515, the adjusted utility capacity 560, the actual utility consumption 565, the actual utility margins 570 and/or the actual incremental costs 575 for reference.

Typically, the payment transactions 580 occur on a periodic basis (e.g., monthly). Completing a payment transaction 580 may involve transmitting a charge (e.g., monthly bill) to a customer and receiving an electronic funds transfer from a customer account. In general, the charge (or bill) includes an amount for the utility consumed in accordance with the usage terms 520 plus any applicable incremental costs. Calculating the charge may include summing the costs incurred during certain time periods (e.g., days, hours). The customer, host, utility supplier, and/or third party institution (e.g., bank) may maintain a customer account including funds designated for paying utility charges. When authorized, the customer account may be debited in an amount equal to the charge.

In one implementation, the host posts and releases details of the payment transaction 580 to customers that access the host through the Internet. The host may present the details of the payment transaction 580 to the customer as a UI (e.g., Web page). The UI may include a customer account balance and a history (e.g., statement) of payment transactions 580.

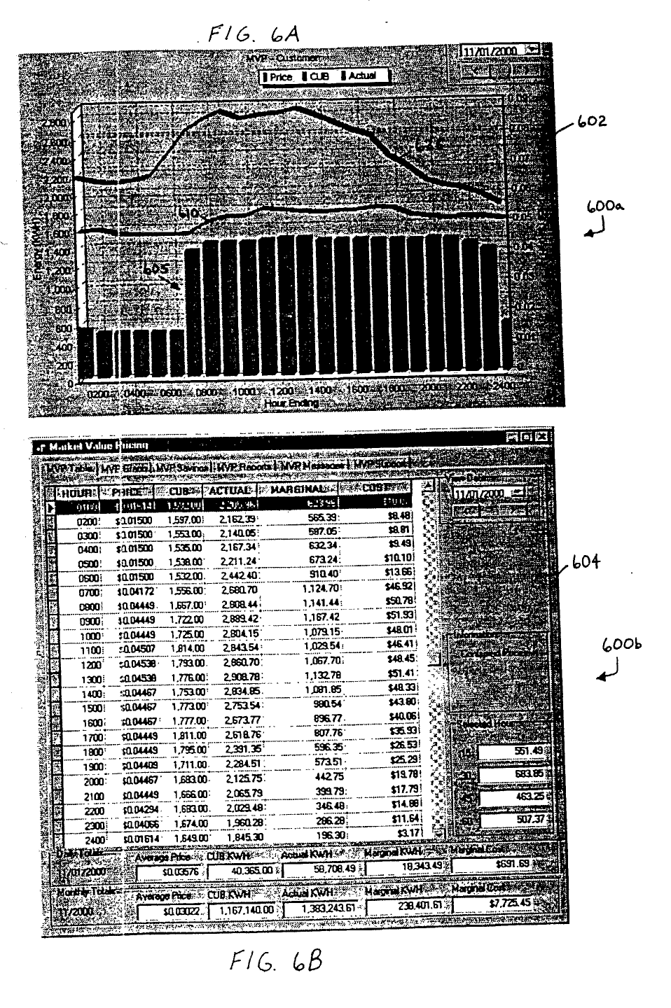

Referring to FIGS. 6A and 6B, a UI 600a and/or a UI 600b may be presented by the host to customers and/or utility suppliers. By viewing the UIs 600a and 600b, a customer is able to review actual utility consumption and expenses and alter future utility consumption. A customer may identify activities resulting in utility overuse and plan to avoid such activities in the future. A customer having several facilities may examine consumption and expenses for all facilities or target a specific facility.

The UI 600a includes a utility chart 602 that graphically represents utility prices 605, utility capacity 610, and utility consumption 625 for a particular customer. The utility prices 605 are depicted as bar graph points indicating the standard utility prices for each hour of a certain day. The utility capacity 610 is depicted as a curve indicating the maximum utility capacity for which the actual standard utility prices are applicable. The utility consumption 625 is depicted as an actual load profile indicating the amount of utility consumed during each hour of a certain day. Areas above the allocated utility capacity 610 and below the utility consumption 625 represent utility margins and incremental costs. Areas below the utility capacity 610 and above the utility consumption 625 represent unused and/or transferable utility capacity.

Referring to FIG. 6B, the UI 600b includes a utility table 604 including the numerical values for the utility prices, utility capacity (e.g. CUB), utility consumption, utility margins, and incremental costs for a particular customer. The utility table 604 also may include numerical values for daily and monthly totals and averages. In general, the data included in the utility table 604 is used to create the utility chart 602 (FIG. 6A) and may be exported to other finance programs for analysis.

The techniques, methods, and systems described herein may find applicability in any computing or processing environment. Various implementations of the systems and techniques described herein may be realized in digital electronic circuitry, or in computer hardware, firmware, software, or in combinations thereof. A system or other apparatus that uses one or more of the techniques and methods described herein may be implemented as a computer-readable storage medium, configured with a computer program, where the storage medium so configured causes a computer system to operate on input and/or generate output in a specific and predefined manner. Such a computer system may include one or more programmable processors that receive data and instructions from, and transmit data and instructions to, a data storage system, and suitable input and output devices. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Generally, a processor will receive instructions and data from a read-only memory and/or a random access memory. Storage devices suitable for tangibly embodying computer instructions and data include all forms of non-volatile memory, including semiconductor memory devices, such as EPROM, EEPROM, and flash memory devices; magnetic disks such as internal hard disks and removable disks; magneto-optical disks; and CD-ROM disks.

These elements also can be found in a desktop or workstation computer as well as other computers suitable for executing computer programs implementing the methods described here, which can be used in conjunction with any content viewing or manipulation software, or any other software capable of displaying portions of a larger body of content. Any of the foregoing may be supplemented by, or implemented in, specially designed ASICs (application specific integrated circuits).

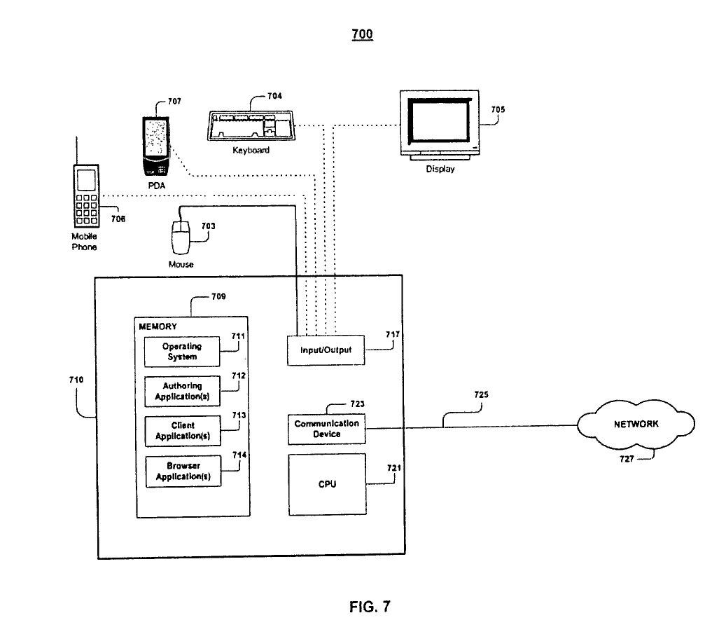

Referring to FIG. 7, a computer system 700 allows a user to perform tasks such as sending, storing, viewing, editing, analyzing, retrieving, and downloading data, including utility consumption data. The computer system 700 of FIG. 7 may also be programmed with computer-readable instructions to enable data to be perceived as stored, viewed, edited, retrieve, downloaded, and otherwise manipulated.

The computer system 700 includes various input/output (I/O) devices (e.g., mouse 703, keyboard 704, display 705, Internet-enabled mobile phone 706, and Internet-enabled PDA 707) and one or more general purpose computers 710 having a central processor unit (CPU) 721, an I/O unit 717 and a memory 709 that stores data and various programs such as an operating system 711, and one or more authoring applications 712 (e.g., programs for word processing, creating spread sheets, and producing graphics), one or more client applications 713 (e.g., programs for accessing online services), and one or more browser applications 714 (e.g., programs for retrieving and viewing electronic documents from the Internet and/or Web). The computer system 700 also includes a communications device 723 (e.g., a satellite receiver, a modem, or network adapter) for exchanging data with a host (not shown) through a communications link 725 (e.g., a telephone line and/or a wireless link) and/or a network. A number of implementations have been described. Nevertheless, it will be understood that various modifications may be made. For example, the Internet-enabled mobile phone 706 and/or Internet-enabled PDA may each include some or all of the components of the general purpose computer 710 and may be used to access a host through the communications link 725 and/or a network 727.

Accordingly, other implementations are within the scope of the following claims. Changes may be made in the combinations, operations, and arrangements of the various parts and elements described herein without departing from the spirit and scope of the invention.

What is claimed is:

1. An Internet-based utility management method comprising:
presenting allocated utility capacity to a customer, the allocated utility capacity including permitted utility consumption during a certain future period of time;
presenting a predicted load profile to a customer, the predicted load profile including predicted utility consumption of the customer for each certain future period of time and presented such that any variation between the allocated utility capacity and the predicted load profile is readily apparent;
presenting available utility capacity, the available utility capacity including an amount by which allocated utility capacity exceeds predicted utility consumption during each certain future period of time; and
transferring available utility capacity between entities according to an established transfer policy.

2. The utility management method of claim 1 wherein the allocated utility capacity represents the utility capacity allocated for consumption during one-hour intervals for each hour of an upcoming day.

3. The utility management method of claim 1 wherein presenting the allocated utility capacity includes distributing shares corresponding to utility capacity.

4. The utility management method of claim 3 wherein the shares are redeemable as payment for utility consumption.

5. The utility management method of claim 3 wherein each share represents a preset amount of a utility and each share is assigned to a certain period of time.

6. The utility management method of claim 1 wherein presenting available utility capacity includes presenting surplus utility capacity, the surplus utility capacity including an amount by which the allocated utility consumption exceeds the predicted utility consumption during a certain time period.

7. The utility management method of claim 6 further comprising determining a utility management program, the utility management program including actions for reducing energy consumption.

8. The utility management method of claim 7 wherein the surplus utility capacity is created by adopting the utility management program.

9. The utility management method of claim 1 further comprising:
presenting offered available utility capacity; and
presenting one or more bids received for offered utility capacity.

10. The utility management method of claim 1 further comprising presenting adjusted utility capacity, the adjusted utility capacity including allocated utility capacity plus incoming transfers of utility capacity and minus outgoing transfers of utility capacity during a certain period of time.

11. The utility management method of claim 10 wherein presenting adjusted utility capacity including redistributing shares corresponding to utility capacity.

12. The utility management method of claim 10 further comprising presenting actual utility consumption.

13. The utility management method of claim 12 wherein presenting the actual utility consumption includes displaying an actual load profile representing the actual amount of utility consumed during certain period of time.

14. The utility management method of claim 12 further comprising presenting actual utility margins, the actual utility margins including deviation of the actual utility consumption from the adjusted utility consumption for certain periods of time.

15. The utility management method of claim 12 further comprising presenting actual incremental costs, the actual incremental costs including costs associated with the deviation of the actual utility consumption from the adjusted utility capacity for certain time periods.

16. The utility management method of claim 1 further comprising completing a payment transaction, the payment transaction including a reimbursement for a charge associated with utility consumption for a certain period of time.

17. The utility management method of claim 1 further comprising displaying a UI having at least one of charts, figures, graphs, text, images, audio, and video.

18. The utility management method of claim 1 further comprising analyzing at least one of pricing data, cost data, weather data, and usage data.

19. The utility management method of claim 1 further comprising delivering data by at least one of e-mail, facsimile, telephone, satellite transmission, the Web and/or the Internet.

20. A computer program for transferring electronic data between users of a communications system, the computer program being stored on a computer readable medium and comprising instructions for:
presenting allocated utility capacity to a customer, the allocated utility capacity including permitted utility consumption during a certain future period of time;
presenting a predicted load profile to a customer, the predicted load profile including predicted utility consumption of the customer for each certain future period of time and presented such that any variation between the allocated utility capacity and the predicted load profile is readily apparent;
presenting available utility capacity, the available utility capacity including an amount by which allocated utility capacity exceeds predicted utility consumption during each certain future period of time; and
transferring available utility capacity between entities according to an established transfer policy.

21. The computer program of claim 20, the computer readable medium comprising a disk.

22. The computer program of claim 20, the computer readable medium comprising a client device.

23. The computer program of claim 20, the computer readable medium comprising a host device.

24. The computer program of claim 20, the computer readable medium comprising a propagated signal.

25. An Internet-based utility management method comprising:
presenting allocated utility capacity to a customer, the allocated utility capacity including permitted utility consumption during a certain future period of time;
presenting a predicted load profile to a customer, the predicted load profile including predicted utility consumption of the customer for each certain future period of time and presented such that any variation between the allocated utility capacity and the predicted load profile is readily apparent; and
transferring utility capacity credit to the customer, the utility capacity credit being issued by another entity and redeemable by the customer as payment for utility consumed by the customer.

26. The utility management method of claim 25 wherein the utility capacity credit includes a coupon issued by at least one of a utility supplier, a utility management host, and a vendor.

27. The utility management method of claim 26 wherein the coupon is issued by a vendor as an incentive for customers to purchase a product or service requiring consumption of the utility.

28. The utility management method of claim 25 wherein the utility capacity credit is redeemable only for utility purchased from a particular utility supplier.

29. The utility management method of claim 25 further comprising presenting adjusted utility capacity is presented, the adjusted utility capacity including allocated utility capacity plus incoming transfers of utility capacity credit during a certain period of time.

30. A computer program for transferring electronic data between users of a communications system, the computer program being stored on a computer readable medium and comprising instructions for:
presenting allocated utility capacity to a customer, the allocated utility capacity including permitted utility consumption during a certain future period of time;
presenting a predicted load profile to a customer, the predicted load profile including predicted utility consumption of the customer for each certain future period of time and presented such that any variation between the allocated utility capacity and the predicted load profile is readily apparent; and
transferring utility capacity credit to the customer, the utility capacity credit being issued by another entity and redeemable by the customer as payment for utility consumed by the customer.

31. The computer program of claim 30, the computer readable medium comprising a disk.

32. The computer program of claim 30, the computer readable medium comprising a client device.

33. The computer program of claim 30, the computer readable medium comprising a host device.

34. The computer program of claim 30, the computer readable medium comprising a propagated signal.
